(19) United States
(12) Patent Application Publication
(10) Pub. No.: US 2017/0239912 A1
(43) Pub. Date: Aug. 24, 2017

(54) Fabric And Method For Producing A Fabric

(71) Applicant: VOITH PATENT GMBH, HEIDENHEIM (DE)

(72) Inventor: ROBERT EBERHARDT, ELLWANGEN (DE)

(73) Assignee: VOITH PATENT GMBH, HEIDENHEIM (DE)

(21) Appl. No.: 15/519,567

(22) PCT Filed: Oct. 12, 2015
(86) PCT No.: PCT/EP2015/073524

§ 371 Date: Apr. 17, 2017

(30) Foreign Application Priority Data
Oct. 15, 2014 (DE) 10 2014 220 828.9

(51) Int. Cl. B32B 5/24; D21F 1/00; B65G 15/32; B32B 5/18; B32B 37/06; C08J 9/36; B32B 5/02

(52) U.S. Cl. CPC B32B 5/245; C08J 9/365; D21F 1/0036; B32B 5/024; B32B 5/18; B32B 37/06; B65G 15/32; C08J 2375/04; B32B 2250/02; B32B 2266/0278; B32B 2266/06; B32B 2266/08; B32B 2274/00; B32B 2307/51; B32B 2413/00; B32B 2307/4026; B32B 2307/412

(57) ABSTRACT

A functional belt has a foam layer and at least one further functional layer. The foam layer and the further functional layer are joined to one another by laser transmission welding, in particular by NIR laser transmission welding. A method for producing a functional belt includes the following method steps: providing a compressible foam layer; providing a further functional layer bringing together the foam layer and the further functional layer and joining the compressible foam layer to the further functional layer by laser transmission welding, in particular by means of NIR laser transmission welding. A technical textile, in particular a fabric for use in a machine for the production or processing of a fibrous material web, preferably press felt of a paper machine, a sealing band or a textile-reinforced insulation material, includes, or is made of, such a functional belt.

The invention relates to a functional belt according to the preamble of claim 1, and to a method for producing a functional belt according to the preamble of claim 11, and to a technical textile which comprises such a functional belt, according to the preamble of claim 15.

Belt-shaped structures which comprise a layer of a foamed material, especially of a soft foam, and in the case of which this foamed material is connected to a further layer, for example to a woven carrier fabric or to a polymer film, are employed in many industrial and technical applications.

The spectrum of applications of these belts is extremely wide. Said belts can be fabric clothings for paper machines, in the case of which a porous foam layer is intended to absorb and dissipate water from the paper, while the woven carrier fabric that is connected to said foam layer provides the mechanical strength and the resistance to abrasion.

Further exemplary applications for such functional belts are conveyor belts for sensitive goods, or else carrier-stabilized compression or sealing belts and flexible textile-armored insulation materials for sound proofing or thermal insulation.

A number of methods for producing such belts are known in the prior art. WO 2005/075733 A1 provides a good overview thereof. One known possibility is for the foam layer to be needle punched, for example onto a woven carrier fabric. However, it is disadvantageous herein that the structure of the foam layer and thus the properties of the latter, such as porosity or also compressibility, are massively damaged in the case of this method. Moreover, the method is not applicable to many carrier layers such as films/foils, for example.

A further known possibility for producing such belts is laminating. Herein, the two layers are interconnected under the influence of pressure and temperature. The connection of the two layers herein is achieved by fusing the surfaces. However, to this end at least one of the layers is heated throughout in order for the contact faces of both layers to be heated to the required melting temperature. On account thereof, damage to the material properties can arise in the case of many materials. In this way, when a foam layer is laminated the latter is also compacted, for example, specifically way beyond the technically desirable extent.

A third method for applying a foam layer to a further functional layer is for the two layers to be adhesively bonded. This is likewise described in WO 2005/075733 A1. However, it is disadvantageous herein that large quantities of the adhesive penetrate the pores of the foam layer and clog said pores when the adhesive is being applied to the foam layer. This typically leads to a deterioration of the porosity of the foam layers that cannot be controlled. A further disadvantage of adhesive bonding is that the adhesive connection, for example in the case of hot-melt adhesive non-wovens, in humid or chemically aggressive environments is released again in places, this potentially leading to the delamination of the belt.

Finally, WO 2005/075733 A1 also describes the layers being welded by means of ultrasonic welding. This joining method can however be used only for joining thermoplastic materials and metallic materials. However, in the case of many applications the foam layers are elastic materials such as polyurethane foams, for example, such that this method cannot be applied here.

It is therefore the object of the invention to provide a method or a belt, respectively, which overcomes the issues of the prior art.

The object is fully achieved by a functional belt according to the descriptive part of claim 1, by a method according to the descriptive part of claim 11, and by an industrial textile according to the descriptive part of claim 15.

Advantageous embodiments and refinements are stated in the dependent claims.

The invention proceeds from the concept of providing a functional belt in the case of which at least one foam layer is connected to a further functional layer, wherein the connection is intended to overcome the disadvantages of the prior art. In particular, the connection is not to intensely compromise the desired properties of the foam layer. Nevertheless, the connection of the two layers is to be very tight and should not be released neither in a humid nor a chemically aggressive environment, even under mechanical stress.

A functional belt hereunder is to be understood to be a belt-shaped planar formation which can be employed in a functional manner, that is to say not in a purely decorative manner, in technical or industrial applications. The application spectrum herein can comprise the application in paper machine clothings, in conveying, compressive, insulation, or sealing belts, and many other applications.

The functional belt according to the invention has a direction in length and a direction in width, wherein the longitudinal extent is larger than the extent in width. Said functional belt according to the invention comprises at least one foam layer and at least one further functional layer. This further functional layer, depending on the application purpose, can fully or partially guarantee the mechanical strength of the functional belt, for example, can have desired surface properties, or facilitate further processing of the belt.

According to the invention, connecting of the foam layer is performed by means of laser transmission welding. Laser transmission welding is a single-stage process in the case of which the procedures of heating and of joining the plastic material run almost simultaneously. Herein, in the range of the laser wavelength one item to bejoined has to have a high transmission rate, and the other item to be joined has to have a high degree of absorption. The transparent item to be joined is penetrated by the laser beam without being heated in an appreciable manner. The laser beam is only absorbed in an amplified manner in a surface-proximal layer in the second item to be joined, wherein the laser energy is converted to thermal energy and the plastic material is fused. The transparent component by virtue of the thermally conductive processes is also plasticized in the region of the joining zone (as per “Wikipedia”). This results in a materially integral connection. The connection thus produced is very stable and is not appreciably weakened even by prolonged contact with an aqueous environment.

The advantage of this welding method lies in that the foam layer and the further functional layer are only interconnected at those points where said layers have also been in mutual contact already prior to welding, on the one hand. In this way, the disadvantageous effect that arises in the case of adhesive bonding, for example, of pores of the foam layer being clogged by adhesive or other materials, on account of which the porosity of the foam layer is disadvantageously modified, is avoided. On the other hand, the disadvantage of the lamination method is also overcome, since only the surface-proximal regions of the two layers are exposed to a comparatively intense heat but the entire layer does not have to be heated throughout.

In the case of one advantageous embodiment, welding is performed by NIR laser transmission welding. Herein, lasers having a wavelength in the range of near infrared light, that is to say having wavelengths of 780 nm-1100 nm, are employed.

In one advantageous embodiment of the invention, the functional belt can moreover have a further layer, for example a non-woven staple-fiber layer, which is likewise fastened to the second surface of the foam layer by means of laser transmission welding, for example.

In one advantageous embodiment of the invention, the foam layer comprises or is composed of a polymer foam. In one particularly advantageous embodiment, the polymer is an elastomer, in particular a polyurethane. One advantage of soft polyurethane foams lies in the elastic properties thereof. Said soft polyurethane foams after compression have a positive restoring capability. This is particularly advantageous when the functional belt is applied in press felts for a paper machine, for example, where the functional belt and in particular the foam layer is compressed at every passage through the nip and thereafter is to expand back largely to the original thickness thereof. However, other polymer foams, such as soft foams based on polyether or polyester, are also possible according to the invention.

In one advantageous embodiment, the foam layer comprises a polymer foam which predominantly has open cells. In one other advantageous embodiment, the foam layer can comprise a polymer foam which predominantly has closed cells, or a combination of open and closed cells, as long as the intention is to achieve non-permeable or slightly permeable functional belts.

In one advantageous embodiment of the invention, the at least one further functional layer comprises of or is composed of a woven fabric, a warp/weft-knitted fabric, a cross-laid scrim, a non-woven fabric, a film/foil, or a polymer foam.

In one advantageous embodiment, either the foam layer or the further functional layer is embodied as a layer that is largely transparent to light in the range of the laser wavelength. The respective other layer at least on a surface is embodied as a layer that is largely absorbent to light in the range of the laser wavelength.

Laser sources that are often employed are high-output diode lasers (HDL, λ=900-1100 nm) and solid-state lasers (Fiber laser, Nd:YAG laser, λ=1060-1090 nm). Since almost all non-reinforced thermoplastics such as, for example, PET, PBT, PA6, PA6.6, PA6.10, polyurethanes, copolyamides, PPS, or polyketones, of natural color have a high transmission rate in this wavelength, these materials can be used for the transparent layer.

In one further advantageous embodiment, the absorbent layer comprises an absorber. This absorber absorbs the light in the range of the laser wavelength. Carbon black particles, a dye, ink, or similar, are examples of such absorbers.

In further advantageous embodiments, this absorber is incorporated in the volume of the absorbent layer, or is applied to at least one surface of the absorbent layer, respectively.

In further advantageous embodiments, the functional layer is embodied as roll goods, as an endless loop, or having a closable seam.

In one particularly preferred embodiment, the foam layer is formed in a planar manner from a plurality of individual foam elements, or comprises the latter. The foam elements herein in some advantageous variants are provided as rectangular sheets. In many applications, the foam elements are disposed beside one another in the direction of length and/or the direction of width in a mutually abutting manner.

A further independent aspect of the invention relates to a method for producing a functional belt. The method according to the invention herein comprises the following process steps:

a) providing a compressible foam layer;

b) providing a further functional layer;

c) converging the foam layer and the further functional layer;

d) connecting the compressible foam layer to the further functional layer by laser transmission welding, in particular by NIR laser transmission welding.

Connecting the two layers by welding has the great advantage that the foam layer and the further functional layer are only interconnected at the mutual contact points. By contrast to adhesive bonding, in the case of which adhesive penetrates the pores of the foam layer and modifies the properties of said pores in a manner that cannot be controlled, for example by reducing the porosity, the pore structures of the foam layer herein remain unmodified. Laser transmission welding, in particular NIR laser transmission welding, herein is particularly suitable for connecting plastic materials in this case. Said laser transmission welding acts in a targeted manner only on the surface or the interface of the two layers, respectively. Other welding methods such as ultrasonic welding, for example, cannot be used in the case of these materials.

The welded connection is moreover very durable also in a humid or chemically aggressive environment.

In one particularly advantageous embodiment of the method, either the foam layer or the further functional layer is embodied as a layer that is largely transparent to light in the range of the laser wavelength, while the respective other layer at least on a surface is embodied as a layer that is largely absorbent to light in the range of the laser wavelength. On account thereof, the laser light penetrates the transparent layer in a largely unimpeded manner up to the interface of the two layers. The light on the interface is absorbed by the surface of the absorbent layer. The interface is heated on account thereof, welding of the two layers thus becoming possible.

It is also provided according to the invention that more than two layers are interconnected. In this way, three layers can be interconnected by laser transmission welding, for example, in that a central layer at least on the two surfaces thereof is embodied so as to be largely absorbent to light in the range of the laser wavelength, while an upper and a lower layer are embodied so as to be largely transparent to light in the range of the laser wavelength. The welding procedure in this instance is performed as has been described above, wherein the laser light initially penetrates the upper layer up to the interface thereof to the central layer, and the laser light in a second simultaneous or a later process penetrates the lower layer up to the interface thereof to the central layer. In one advantageous embodiment, this central layer can be embodied as a foam layer or as a further functional layer.

In one further preferred embodiment of the method, the at least two layers are placed on top of one another and welded to one another under a joining pressure. This joining pressure can be in a range between 1 N/cm² and 10 N/cm², for example. In one advantageous embodiment of the method, the joining pressure can be applied in that the foam layer and the at least one further functional layer are conjointly urged against a fixed face, a fixed roller, or similar. The joining pressure can be applied in that the laser is equipped with roller optics, for example, and presses onto the layers by means of these roller optics. Alternatively or additionally thereto, a joining pressure can also be built up in that the layers under tensile stress are guided over a roller, on account of which a contact pressure is generated on the roller. In such an embodiment of the method, welding is performed by way of this roller. A joining pressure can also be built up in that the layers are guided over a static or rotating element which is pressed into the belt.

In many embodiments of the method slight compacting of the foam layer arises due to welding under joining pressure. The thickness of the foam layer after welding thus is often between 90%-100% of the original thickness.

In one particularly preferred embodiment, the method according to the invention comprises a further process step in which the foam layer under the influence of pressure and temperature is at least partially compacted. This compacting herein can be performed prior to and/or after welding. Commercially available foam layers which often have a thickness of 10-20 mm can be used for example in the production of functional belts for use in paper or cellulose machines, in particular in press felts. Said commercially available foam layers are not only excessively thick in terms of the product to be produced, but often have excessive porosity and an excessive pore size. Both the latter can be improved or modified, respectively, by compacting. The foam layers are often compacted to a thickness of 1 mm-5 mm. Other thicknesses are however also possible, depending on the application.

In one most particularly advantageous embodiment of the method, the foam layer after a compacting step is cooled under pressure. Preferably, the pressure that has been applied for compacting herein is largely maintained. A special cooling device can be provided for cooling. Renewed expansion of the compressed foam layer is prevented by cooling under pressure. It is thus possible for the foam layer to be compacted to a uniform target thickness.

The permeability of the functional belts is preferably less than approx. 500 cfm (corresponding to 0.23 m³/s), particularly preferably less than approx. 200 cfm (corresponding to 0.09 m³/s).

In one advantageous embodiment of the method, the foam layer and the further functional layer are in each case provided as a web-shaped layer, wherein the two web-shaped layers are of an identical width. However, it can also be provided in other embodiments that one layer, preferably the foam layer, is provided in the form of a plurality of individual foam elements, or is formed from these foam elements, respectively. These individual elements in this instance can be disposed beside one another and/or sequentially, preferably in a mutually abutting manner. It is thus possible, for example, that the foam layer is provided from a plurality of foam elements in the form of narrow web-shaped layers which are disposed beside one another, the total width of the latter corresponding substantially to the width of the further functional layer. In one other embodiment of the method, the foam layer can be provided from a plurality of foam elements, wherein the foam elements have substantially the same width as the further functional layer but are significantly shorter than the latter. These foam elements can then be disposed sequentially on the functional layer until the desired length of the functional belt has been reached.

It can moreover be advantageous for the foam elements to be adhesively bonded in a temporary manner and for handling to be simplified, for example, during processing of the foam elements, or during the production process of the functional belt, respectively. To this end, a water-soluble adhesive agent which after completion of the functional belt, especially after welding by NIR laser transmission welding, is washed out again and thus does not have any influence on the properties of the functional belt can be used, for example.

Finally, a further independent aspect of the invention relates to a technical textile, in particular a fabric clothing, for use in a machine for producing or processing a fibrous web, preferably a press felt of a paper machine, a sealing belt or a textile-armored insulation material. These technical textiles are characterized in that the former comprise a functional belt according to one of claims 1 to 10, or are composed thereof. Such a technical textile according to the invention can in particular comprise even further textile layers and/or layers from staple fibers on the upper and/or lower side of the functional belt. In one advantageous embodiment of the technical textile as a fabric clothing in a paper machine it can be provided that a non-woven layer is applied to the foam layer of the functional belt by means of laser welding or else by means of laminating. A hot-melt adhesive can be used for connecting the non-woven layer to the foam layer when laminating, for example. In one particularly preferred embodiment, the fabric clothing, apart from the functional belt and the non-woven layer applied thereto, can comprise even further layers, in particular further non-woven layers.

The use of a functional belt according to the invention as a technical textile or as an important component part of such a technical textile, can take place in many different ways. One advantageous embodiment of a press felt can be in such a manner that the felt comprises a carrier structure and needled non-woven layers on one side or on both sides, for example. In this case, a plurality of further functional layers are provided conjointly with the carrier layer and the non-woven layer or non-woven layers. Furthermore, a foam layer, in particular an elastic open-cell foam layer which according to the invention is connected to the non-woven layer on the paper side by laser transmission welding can be provided on the paper side. To this end, the foam is advantageously embodied as a layer that at least on the surface thereof is largely absorbent to light in the range of the laser wave length. During production, the laser light under the joining pressure can be directed from the direction of the running side through the felt structure. In this case, the carrier structure and the non-woven layer or non-woven layers, respectively, can be embodied so as to be largely transparent to light in the range of the laser wavelength.

Such a functional belt when used as a press felt on the surface thereof that contacts the paper would have a foam layer. In general, felts having such a foam layer as a paper-contacting surface can be advantageous since said surface has a minor tendency toward marking since, by contrast to paper-contacting non-woven layers, no non-woven fibers can be pressed into the paper surface. Moreover, despite the comparatively smooth surface of the foam layers, high rates of permeability can be achieved when using respective foams. This can be highly advantageous for dewatering the paper web.

In order for the foam layer to be compacted and solidified, it can be provided that a press felt such as the one that has been described above, for example, especially after welding of the foam layer to the paper-side non-woven layer is guided over a hot roller. Such a roller is preferably operated at temperatures between 100° C. and 250° C., particularly preferably between 160° C. and 210° C. The surface of the foam layer is also smoothed by this treatment.

Open-cell soft polyurethane foams or filter foams, respectively, having a porosity of 30-60 PPI, for example, and a thickness of 2 to 12 mm, in particular 3-8 mm, are preferably used as a foam for a felt of this type or else for other functional belts according to the invention. This thickness can optionally be further reduced by a compacting process such that the foam layer in the finished product has a lesser thickness.

In one further advantageous embodiment, a functional belt having a plurality of further functional layers can again be provided. In this way, for example, a carrier structure can be provided, one or a plurality of non-woven layers being attached to the paper-side surface of said carrier layer preferably by needling. In turn, a foam layer can be fastened to the surface of the topmost non-woven layer by transmission welding. The foam layer herein is embodied so as to be largely absorbent to light in the range of the laser wavelength. Should no paper-contacting foam layer be desired in the specific application, a non-woven layer as a further functional layer which in this instance provides the paper-contacting upper side of the felt can be provided. This non-woven layer can either be fastened in a conventional manner by needling. However, in particularly advantageous embodiments, this paper-contacting non-woven layer can also be fastened to the foam layer by means of laser transmission welding. Non-woven layers are thus fastened by means of welding to both sides of the foam layer in this embodiment. This is possible when the further functional layers are embodied so as to be largely transparent to light in the range of the laser wavelength, while the foam layer is embodied so as to be absorbent in this range.

Also in this embodiment, the foam layer can again be compacted and solidified by heat and pressure, wherein said compacting may take place prior to and/or after the first and/or second welding.

The invention will be described in more detail hereunder by way of example by means of schematic figures which are not to scale.

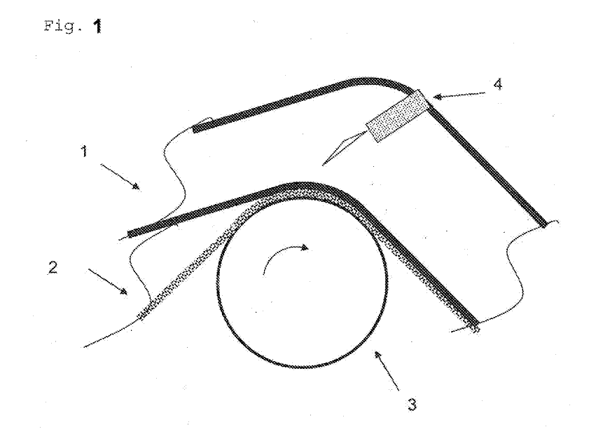

FIG. 1 shows a fragment of an embodiment of the method according to the invention.

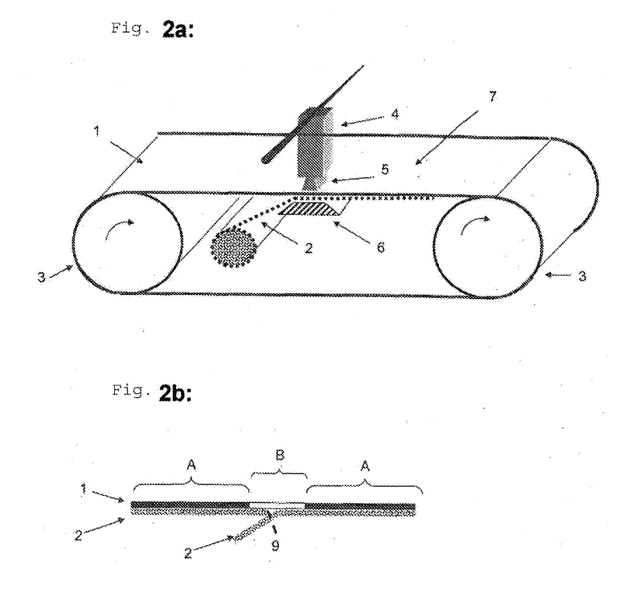

FIG. 2 shows a fragment of a further embodiment of the method according to the invention.

FIG. 2b schematically shows the tailoring of a foam layer at an abutment point.

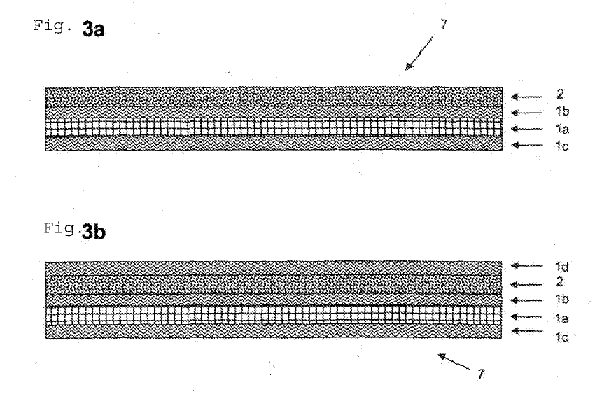

FIGS. 3a and 3b show two embodiments of the use of a functional belt according to the invention as a press felt.

FIG. 1 shows a foam layer 2 and a further functional layer 1. The further functional layer 1 can be a woven fabric, for example. This woven fabric in the functional belt later provides inter alia the desired dimensional stability and tensile strength. This woven fabric in one advantageous embodiment is composed of a woven multifilament fabric or of a woven monofilament fabric.

The filaments herein can be composed of a multiplicity of polymers. The further functional layer 1 in one advantageous embodiment is composed of a woven monofilament fabric from polyamide 6 having yarn diameters of 0.3 mm to 0.5 mm, preferably of 0.4 mm. An open-cell polyurethane foam can be used as the foam layer 2. In the embodiment shown in FIG. 1, the further functional layer 1 is transparent to the light of the laser 4. By contrast, the foam layer 2 is absorbent in the range of the laser wavelength. This is often evident in the coloration of the foam layer. Foam layers 2 of this type are thus usually anthracite, black, or grey in color. The foam layer 2 has optionally already been compacted in a further process step. Should the functional belt be provided for employment in a press felt for a paper machine, the foam belt 2 when provided often has a thickness in the range of 3 mm to 15 mm.

The foam layer 2 and the further functional layer 1 are converged and conjointly guided over a roller 3. Contact pressure onto the roller 3 results from applying a web tension and by wrapping of the roller 3, on account of which the desired joining pressure is created. The joining pressure in many applications is between 1 N/cm² and 5 N/cm². A laser 4 is attached above the roller 3. Said laser in an advantageous embodiment emits light in the NIR range. The usual output of such laser 4 is in the range of 100 W to 600 W (linear). In principle, however, lasers which illuminate an area can also be provided. The laser 4 in FIG. 1 has a linear width of 30 mm. The light penetrates the further functional layer 1 up to the interface to the foam layer 2. Said light there is absorbed by the foam layer, on account of which heating and welding of the two layers takes place. However, the use of planar laser fields which can be generated by respective optics is also conceivable.

In the embodiment of FIG. 1, the foam layer 2 and the further functional layer 1 are guided past below the laser light. The speeds used therein are relatively minor, in the range between 20 mm/s and 100 mm/s, but can also be higher or lower, depending on the material and the laser. A functional belt 7 having a width of 30 mm is created after welding. Wider belts can be produced in that a plurality of lasers which are disposed beside one another, or lasers having wide lines are used, for example. Moreover, the foam layer 2 and the further functional layer can be run under the laser 2 multiple times in an offset manner.

FIG. 2 shows an embodiment of the method according to the invention in which the laser 4 is positioned above the further functional layer 1 and the foam layer 2. In the embodiment illustrated, an endless further functional layer 1 is set up on two rollers 3. The tensile stress herein is usually less than 2 kN/m, especially less than 1 kN/m. A foam layer 2, especially an open-cell soft polyurethane foam, is incorporated between the further functional layer 1 and a fixed element 6. The foam layer is usually embodied so as to be absorbent to NIR light. When viewed, such foam layers 2 often appear to be dark, for example of anthracite color. The thickness of the foam layer 2 is preferably in the range of 3 mm and 15 mm. The required joining pressure in this embodiment is generated in that a fixed element 6, preferably a polyamide sheet, is attached below the foam layer. The joining pressure by means of optics 5, especially roller optics 5 which are attached to the laser 4 is generated on the layers 1, 2 lying below said optics 5. The joining pressures generated in such a manner, in the context of roller optics having a width of 30 mm, in preferred embodiments are between 2 N and 10 N, wherein pressures of 40 N are also possible, however. In particularly preferred embodiments, the joining pressures are between 10 N and 20 N, but in individual cases can also be thereabove or therebelow, for example between 4 N and 6 N. Should other optics be used, for example wider roller optics, these pressure values can be adapted in a corresponding manner. The output that is generated by the laser 4 in preferred embodiments is between 100 W and 500 W, but can also be up to 600 W or more. The laser output is particularly preferably between 200 W and 300 W. However, a higher or lower laser output can also be provided in special applications. These output figures are again related to roller optics having a width of 30 mm, and can be adapted in a corresponding manner when other optics are used. In the case of roller optics having a width of 60 mm, double these output values can be applied, for example.

In the case of the embodiment shown in FIG. 2, means by means of which the laser 4 can be moved transversely to the running direction of the layers are provided. The laser 4 can thus be fastened so as to be movable on a traversing unit. The laser 4 is usually moved at a speed of less than 200 mm/s, preferably less than 100 mm/s, particularly preferably at 40 mm/s to 60 mm/s. The further functional layer 1 and the foam layer 2 can rest or else move along the web running direction of said layers during this movement of the laser. The further functional layer 1 by way of the movement of the laser 4 is welded to the further functional layer in a strip having the width of the optics 5. In the case in which the further functional layer 1 and the foam layer 2 are resting, a welded strip which is oriented transversely to the running direction of the layers is thus created. When usual optics are used, the strips thus generated are between 20 mm and 100 mm, especially between 25 mm and 40 mm, wide. After welding, the belt 7 from the further functional layer that is welded to the foam layer 2 is moved forward in the running direction of the belt by the width of the welded strip. The process of welding can thereafter be continued as has been described above. The laser 4 in the case of the subsequent welding procedure is expediently moved across the layer in the opposite direction. The entire functional belt can be welded in this way, if desirable.

As is shown in FIG. 2b, the foam layer 2 prior to final welding, that is to say prior to final traversing of the laser 4, at the abutment points can be tailored such by means of a cutting device 9 that a clean abutment is created. The region B of the abutment point has not yet been welded here, while the other regions A have already been welded as has been described above. The non-welded region B herein can have the width of the optics 5 of the laser 4, or else be narrower or wider.

FIG. 3a shows a potential example of the the use of a functional belt 7 according to the invention as a technical textile, especially as a press felt 7 for a paper machine. The felt 7 comprises a plurality of further functional layers 1a, 1b, 1c, specifically a carrier structure 1a and non-woven layers 1b, 1c that are needled to both sides. The carrier structure 1a can for example be composed of a woven fabric, a warp/weft-knitted fabric, a cross-laid scrim, or can comprise the latter.

A foam layer 2, in particular an elastic open-cell foam layer 2, is furthermore provided on the paper side in FIG. 3a, said foam layer 2 according to the invention being connected to the non-woven layer 1b on the paper side by laser transmission welding. To this end, the foam is advantageously embodied as a layer that at least on the surface thereof is largely absorbent to light in the range of the laser wavelength. During production, the laser light under the joining pressure can be directed from the direction of the running side through the felt structure, for example. In this case, the carrier structure 1a and the non-woven layer or non-woven layers 1b, 1c, respectively, can be embodied so as to be largely transparent to light in the range of the laser wavelength.

Such a press felt 7 on the paper-contacting surface thereof has a foam layer 2. In general, felts 7 having such a foam layer 2 as a paper-contacting surface can be advantageous since said surface has a minor tendency toward marking since, by contrast to paper-contacting non-woven layers, no non-woven fibers can be pressed into the paper surface. Moreover, despite the comparatively smooth surface of the foam layers, high rates of permeability can be achieved when using respective foams. This can be highly advantageous for dewatering the paper web.

In order for the foam layer 2 to be compacted and solidified, it can be provided that a press felt such as the one that has been described above, in particular, after welding of the foam layer 2 to the paper-side non-woven layer 1b, is guided over a hot roller. Such a roller is preferably operated at temperatures between 100° C. and 250° C., particularly preferably between 160° C. and 210° C. The surface of the foam layer 2 is also smoothed by this treatment.

Open-cell soft polyurethane foams or filter foams, respectively, having a porosity of 30-60 PPI, for example, and a thickness of 2 to 12 mm, in particular 3-8 mm, can preferably be used as a foam for a felt of this type or else for other functional belts according to the invention. This thickness can optionally be further reduced by a compacting process such that the foam layer in the finished product has a lesser thickness.

FIG. 3b shows a further advantageous use of the one functional belt 7 having a plurality of further functional layers 1a, 1b, 1c, 1d as a press felt 7. A carrier structure 2 is provided herein, one or a plurality of non-woven layers 1b being attached to the surface on the paper side of said carrier structure preferably by needling. In turn, a foam layer 2 can be fastened to the surface of the topmost non-woven layer 1b by transmission welding. The foam layer 2 herein is preferably embodied so as to be largely absorbent to light in the range of the laser wavelength. A non-woven layer 1d as a further functional layer which in this instance provides the paper-contacting upper side of the felt 7 is provided on the paper-side surface of the foam layer 2 in FIG. 3b. This non-woven layer 1d can either be fastened in a conventional manner by needling. However, in particularly advantageous embodiments, this paper-contacting non-woven layer 1d can again be fastened to the foam layer 2 by means of laser transmission welding. Non-woven layers 1b, 1d are thus fastened by means of welding to both sides of the foam layer 2 in this embodiment. This is possible when the further functional layers 1a, 1b, 1c, 1d are embodied so as to be largely transparent to light in the range of the laser wavelength, while the foam layer 2 is embodied so as to be absorbent in this range.

The foam layer 2 can again be compacted and solidified by heat and pressure also in the case of this embodiment, wherein this compacting can take place prior to and/or after the first and/or second welding.

The functional belt in FIG. 3b on that side of the carrier structure la that faces away from the paper has a further non-woven layer 1c. Depending on the specific application, this non-woven layer 1c can also be dispensed with. Alternatively, however, even further non-woven layer can be provided.

### LIST OF REFERENCE SIGNS

1, 1a, 1b, 1c, 1d Further functional layer

2 Foam layer

3 Roller

4 Laser

5 Optics

6 Fixed element

7 Functional belt

9 Cut

A Welded region

B Non-welded region

1-15. (canceled)

16. A functional belt having a direction in length and a direction in width, the functional belt comprising:
a foam layer and at least one functional layer joined to said foam layer by laser transmission welding.

17. The functional belt according to claim 16, wherein said foam layer and said at least one functional layer are interconnected by near infrared laser transmission welding.

18. The functional belt according to claim 16, wherein said foam layer comprises or consists of a polymer foam.

19. The functional belt according to claim 18, wherein said polymer foam comprises an elastomer.

20. The functional belt according to claim 18, wherein said polymer foam comprises a polyurethane.

21. The functional belt according to claim 16, wherein said foam layer comprises one or both of an open-cell polymer foam or a closed-cell polymer foam.

22. The functional belt according to claim 16, wherein said at least one functional layer consists of or comprises a material selected from the group consisting of a woven fabric, a warp/weft-knitted fabric, a cross-laid scrim, a non-woven fabric, a film, a foil, and a polymer foam.

23. The functional belt according to claim 16, wherein either said foam layer or said at least one functional layer is a layer that is largely transparent to light in a range of a laser wavelength, while the respective other said layer has at least a surface with an absorbent layer that is largely absorbent to light in the range of the laser wavelength.

24. The functional belt according to claim 23, wherein the absorbent layer comprises an absorber which absorbs light in the range of the laser wavelength.

25. The functional belt according to claim 24, wherein said absorber is selected form the group consisting of a dye, an ink, and carbon black.

26. The functional belt according to claim 24, wherein said absorber is incorporated in a volume of the absorbent layer, or said absorber is applied to at least one surface of the absorbent layer.

27. The functional belt according to claim 16, wherein the functional belt is embodied as roll goods, as an endless loop, or a belt with a closable seam.

28. The functional belt according to claim 16, wherein said foam layer is composed of, or comprises, a plurality of individual foam elements disposed in one or both of the direction of length or the direction of width in a mutually abutting relationship.

29. A method for producing a functional belt, the method comprising the following process steps:
i. providing a compressible foam layer;
ii. providing a further functional layer;
iii. converging the foam layer and the further functional layer; and
iv. connecting the compressible foam layer to the further functional layer by laser transmission welding.

30. The method according to claim 29, wherein the connecting step comprises near-infrared laser transmission welding.

31. The method according to claim 29, which comprises placing the foam layer and the functional layer on top of one another and welding the layers under a joining pressure.

32. The method according to claim 29, which further comprises at least one further process step, to be performed prior to and/or after welding, of at least partially compacting the foam layer under the influence of elevated pressure and elevated temperature.

33. The method according to claim 32, which comprises cooling the foam layer under pressure after the compacting step.

34. A technical textile, comprising a functional belt according to claim 16 configured for use in a machine for producing or processing a fibrous web.

35. The technical textile according to claim 34, configured as a fabric clothing in a paper-making machine, as a press felt of a paper machine, as a sealing belt, as a textile-armored insulation material, or as a component part of such a technical textile.
